(19) United States
(12) Patent Application Publication
(10) Pub. No.: US 2026/0242247 A1
(43) Pub. Date: Aug. 20, 2026

(54) REMOVAL AND DESTRUCTION OF PERFLUOROALKYL AND POLYFLUOROALKYL SUBSTANCES FROM CONTAMINATED WATER

(71) Applicant: Evoqua Water Technologies LLC, Pittsburgh, PA (US)

(72) Inventors: Simon P. Dukes, Chelmsford, MA (US); Savvas Hadjikyriacou, Tyngsboro, MA (US)

(21) Appl. No.: 19/161,508

(22) PCT Filed: Mar. 8, 2024
(86) PCT No.: PCT/US2024/019033

§ 371 Date: Sep. 2, 2025

Related U.S. Application Data
(60) Provisional application No. 63/450,694, filed on Mar. 8, 2023.
(60) Provisional application No. 63/451,729, filed on Mar. 13, 2023.

(51) Int. Cl. C02F 1/26; C02F 1/12; C02F 1/52; C02F 101/36

(52) U.S. Cl. CPC C02F 1/26; C02F 1/12; C02F 1/52; C02F 2001/5218; C02F 2101/36; C02F 2209/105; C02F 2303/18

(57) ABSTRACT

A method of separating perfluoroalkyl and/or polyfluoroalkyl substances (PFAS) from water contaminated with at least one perfluoroalkyl and/or polyfluoroalkyl substance and containing dissolved solids. At least one non-polar solvent and/or polar aprotic solvent is added and mixed into the contaminated water to form a solvent/water solution. The water is separated from the solvent/water solution. The at least one perfluoroalkyl and/or polyfluoroalkyl substance migrates to the at least one non-polar solvent and/or polar aprotic solvent and the dissolved solids crystallize during mixing of the solvent/water solution and/or separation of the water. The precipitated solids are separated from the at least one non-polar solvent and/or polar aprotic solvent containing the at least one perfluoroalkyl and/or polyfluoroalkyl substance. Also, further subjecting the at least one non-polar organic solvent and/or polar aprotic organic solvent containing the at least one perfluoroalkyl and/or polyfluoroalkyl substance to supercritical water oxidation (SCWO).

### CROSS-REFERENCE TO RELATED APPLICATIONS

This application is National Stage Entry of International Application No. PCT/US2024/019033 filed Mar. 8, 2024, which claims priority under 35 U.S.C. § 119 (e) to U.S. Provisional Patent Application Nos. 63/450,694 filed Mar. 8, 2023 and 63/451,729 filed Mar. 13, 2023, the disclosures of which are hereby incorporated by reference in their entireties.

### BACKGROUND OF THE INVENTION

### Field of the Invention

The present invention is directed to a method of separating perfluoroalkyl and/or polyfluoroalkyl substances (PFAS) from water contaminated with perfluoroalkyl and/or polyfluoroalkyl substances and containing dissolved solids and a method of removing and destroying perfluoroalkyl and/or polyfluoroalkyl substances from water contaminated with perfluoroalkyl and/or polyfluoroalkyl substances and containing dissolved solids.

### Description of Related Art

Perfluoroalkyl and/or polyfluoroalkyl substances, referred to herein as “PFAS”, have become increasingly popular fluoro-surfactants. Presently thousands of perfluoroalkyl and/or polyfluoroalkyl compounds are commonly used in surface treatments and coatings applied to consumer products, such as carpets, upholstery, stain resistant apparel, cookware, paper, packaging, and the like, and PFAS are also found in chemicals used for chemical plating, electrolytes, lubricants, and the like, which may eventually end up in the water supply. Further, PFAS have been utilized as key ingredients in aqueous film forming foams (AFFFs). AFFFs have been the product of choice for firefighting at military and municipal fire training sites around the world. AFFFs have also been used extensively at oil and gas refineries for both fire training and firefighting exercises. AFFFs work by blanketing spilled oil/fuel, cooling the surface, and preventing re-ignition. PFAS in AFFFs have contaminated the groundwater at many of these sites and refineries, including more than 100 U.S. Air Force sites.

Although used in relatively small amounts, perfluoroalkyl and/or polyfluoroalkyl compounds are readily released into the environment where their extreme hydrophobicity as well as negligible rates of natural decomposition result in environmental persistence and bioaccumulation. It appears that even low levels of bioaccumulation may lead to serious health consequences, even with long term exposure to contaminant concentrations in the part-per-trillion range. The environmental effects of these compounds on plants and microbes are as yet largely unknown. Nevertheless, serious efforts to limit the environmental release of PFAS have begun and include potential restrictions in use of PFAS and rendering harmless any solids, liquids, and gases that are already contaminated with PFAS.

PFAS removal has become a significant water treatment effort in the last 10 years. PFAS contamination must be controlled to below 70 ppt based on U.S. Environmental Protection Agency (EPA) recommendation. In many cases, such as municipal drinking water treatment, a much lower level (MCL of 20 ppt maximum) needs to be achieved. Currently, the most reliable and economical methods are granulated active carbon (GAC) and anion exchange resin. The former is based on physical absorption, and the later has an additional ion exchange effect. Electrochemical oxidation can also be used to remove PFAS from PFAS contaminated water; however, the energy penalty is high due to the low concentration of PFAS. Reverse osmosis is another option, but there is a natural limit due to reaching limiting concentrations of the other species in the water, bringing the system to either the limit of solubility for these compounds or the limit of pressure of the system.

### SUMMARY OF THE INVENTION

The present invention is directed to a method of separating perfluoroalkyl and/or polyfluoroalkyl substances (PFAS) from water contaminated with at least one perfluoroalkyl and/or polyfluoroalkyl substance and containing dissolved solids. At least one non-polar solvent and/or at least one polar aprotic solvent is added and mixed into the contaminated water to form a solvent/water solution. The water is separated from the solvent/water solution. The at least one perfluoroalkyl and/or polyfluoroalkyl substance migrates to the at least one non-polar solvent and/or the at least one polar aprotic solvent and the dissolved solids crystallize during mixing of the solvent/water solution and/or separation of the water. The precipitated solids are separated from the at least one non-polar solvent and/or at least one polar aprotic solvent containing the at least one perfluoroalkyl and/or polyfluoroalkyl substance.

The contaminated water may contain 0.5-2,000,000 ppb of PFAS and 300-200,000 mg/L of total dissolved solids (TDS). The boiling point of each of the at least one non-polar organic solvent and/or at least one polar aprotic organic solvent may be 150° C.-400° C. An amount of the at least one non-polar organic solvent and/or at least one polar aprotic organic solvent added to the contaminated water and an amount of contaminated water (solvent:water) may be 1:50 to 1:1.

The solvent/water solution may be agitated or stirred to provide contact between the contaminated water and the at least one non-polar organic solvent and/or at least one polar aprotic organic solvent.

Distillation or evaporation may be used to separate the water from the solvent/water solution. The distillation or evaporation may be conducted at a temperature above the boiling point of water and below the boiling point of the at least one non-polar organic solvent and/or at least one polar aprotic organic solvent. The water may be separated from the solvent/water solution by spray drying. The solvent/water solution may be agitated during entry into water separation and/or during water separation.

After separation of the water from the solvent/water solution, the water contains 0-10 ppt of PFAS, and the at least one non-polar organic solvent and/or at least one polar aprotic organic solvent containing the PFAS and separated from the crystallized solids contains 15 wt % or less residual water.

The present invention is further directed to a method of separating and destroying perfluoroalkyl and/or polyfluoroalkyl substances (PFAS) in water contaminated with PFAS and containing dissolved solids. At least one perfluoroalkyl and/or polyfluoroalkyl substance is separated from the contaminated water using the inventive method described above, and the at least one non-polar organic solvent and/or at least one polar aprotic organic solvent containing the at least one perfluoroalkyl and/or polyfluoroalkyl substance is subjected to supercritical water oxidation (SCWO). An exothermic reaction between the at least one non-polar organic solvent and/or at least one polar aprotic organic solvent and the supercritical water may provide heat that fuels the supercritical water oxidation (SCWO). The contaminated water may be preheated prior to separation of the water from the solvent/water solution using heat generated by the supercritical water oxidation (SCWO).

### BRIEF DESCRIPTION OF THE DRAWINGS

FIG. 1 is a schematic showing the separation of water from the solvent/water solution according to the inventive method;

FIG. 2 is a schematic of a spray drying apparatus used in one embodiment of the inventive method to separate the water from the solvent/water solution; and

FIG. 3 is a schematic of a fluidized bed heat exchanger that can optionally be used to heat the contaminated water or in the supercritical water oxidation of the inventive methods.

### DESCRIPTION OF THE INVENTION

As used herein, any numerical values are expressed using a period as a decimal point and a comma as a thousand separator, for example, 1,234 would be one thousand two hundred thirty four, and 1.2 would be one and two tenths. Unless otherwise expressly specified, all numbers such as those expressing values, ranges, amounts or percentages may be read as if prefaced by the word “about”, even if the term does not expressly appear. Any numerical range recited herein is intended to include all sub-ranges subsumed therein. For example, a range of “1 to 10” is intended to include any and all sub-ranges between and including the recited minimum value of 1 and the recited maximum value of 10, that is, all subranges beginning with a minimum value equal to or greater than 1 and ending with a maximum value equal to or less than 10, and all subranges in between, e.g., 1 to 6.3, or 5.5 to 10, or 2.7 to 6.1. Plural encompasses singular and vice versa. When ranges are given, any endpoints of those ranges and/or numbers within those ranges can be combined with the scope of the present invention. “Including”, “such as”, “for example” and like terms means “including/such as/for example but not limited to”.

The present invention is directed to a method of separating perfluoroalkyl and/or polyfluoroalkyl substances from water contaminated with perfluoroalkyl and/or polyfluoroalkyl substances and containing dissolved solids, and a method of removing and destroying perfluoroalkyl and/or polyfluoroalkyl substances from water contaminated with perfluoroalkyl and/or polyfluoroalkyl substances and containing dissolved solids.

The starting material for the inventive method is water contaminated with perfluoroalkyl and/or polyfluoroalkyl substances, referred to herein as “PFAS”, and containing dissolved solids.

Perfluoroalkyl and polyfluoroalkyl substances are organic compounds consisting of fluorine, carbon, and heteroatoms, such as oxygen, nitrogen and sulfur, that have a non-polar hydrophobic carbon (alkyl) chain structure that is fully saturated with fluorine atoms attached to a hydrophilic polar functional group. In perfluoroalkyl substances, the carbon chain has carbon-fluorine bonds, and in polyfluoroalkyl substances, the carbon chain has carbon-fluorine bonds and carbon-hydrogen bonds. The carbon chains may have 4-12 carbon atoms. Common PFAS include: perfluorooctanoic acid (PFOA), perfluorooctanesulfonic acid (PFOS), perfluorobutanoic acid (PFBA), perfluorobutanesulfonic acid (PFBS), perfluorohexanoic acid (PFHxA), perfluorohexanesulfonic acid (PFHxS), and short-chain organofluorine chemical compounds, such as the ammonium salt of hexafluoropropylene oxide dimer acid (HFPO-DA) fluoride (also known as GenX).

The PFAS-contaminated water may contain in total 0.5-2,000,000 ppb (500-2,000,000,000 ng/L) of at least one PFAS, for example, at least 0.5 ppb (500 ng/L) of at least one PFAS, at least 50 ppb (5,000 ng/L) of at least one PFAS, or at least 100 ppb (10,000 ng/L) of at least one PFAS, and at most 2,000,000 ppb (2,000,000,000 ng/L) of at least one PFAS, at most 20,000 ppb (2,000,000 ng/L) of at least one PFAS, at most 1500 ppb (150,000 ng/L) of at least one PFAS.

The PFAS-contaminated water also contains dissolved solids, which can include but are not limited to inorganic salts. The total dissolved solids (TDS) contained in the PFAS-contaminated water may be present in an amount of 300-200,000 mg/L, for example, at least 300 mg/L TDS or at least 100 mg/L TDS, and at most 200,000 mg/L TDS, at most 35,000 mg/L TDS, or at most 10,000 mg/L TDS.

At least one non-polar organic solvent and/or at least one polar aprotic organic solvent is added to the PFAS-contaminated water to form a solvent/water solution. Non-polar organic solvents contain bonds between atoms with similar electronegativities, such as carbon and hydrogen. The bonds between atoms with similar electronegativities lack partial charges resulting in a compound having little or no dipole moment. Examples of non-polar organic solvents include: nonane (C₉H₂₀), decane (CH₃(CH₂)₈CH₃), hexadecane (C₁₆H₃₄), naphthalene (C₁₀H₈), and the like. Polar aprotic organic solvents contain some polar bonds, for example C═O and/or S═O, but lack any O—H or N—H bonds. Examples of polar aprotic organic solvents include: dimethyl sulfoxide ((CH₃)₂SO), dimethyl sulfolane (C6H12O2S), formamide (CH3NO), dimethyl formamide (C₃H₇NO), and N-methylpyrollidinone (C₅H₉NO).

The boiling point of each of the at least one non-polar organic solvent and/or at least one polar aprotic organic solvent may be 150° C. or higher, for example, 170° C. or higher or 200° C. or higher, and 110° C. or lower.

A sufficient amount of non-polar organic solvent and/or polar aprotic organic solvent may be added to the PFAS-contaminated water to allow all of the PFAS in the PFAS-contaminated water to migrate into the non-polar organic solvent and/or polar aprotic organic solvent without the non-polar organic solvent and/or polar aprotic organic solvent becoming saturated. Therefore, the amount of non-polar organic solvent and/or polar aprotic organic solvent added to the PFAS-contaminated water is added as a function of the concentration of the PFAS in the PFAS-contaminated water and the non-polar organic solvent and/or polar aprotic organic solvent that is utilized. The ratio between the amount of the non-polar organic solvent and/or polar aprotic organic solvent added to the PFAS-contaminated water and the amount of PFAS-contaminated water (solvent:water) may be 1:50 to 1:1, for example, 1 part solvent per 50 parts PFAS-contaminated water, 1 part solvent per 20 parts PFAS-contaminated water, 1 part solvent per 10 parts PFAS-contaminated water, or 1 part solvent per 1 part PFAS-contaminated water.

After adding the non-polar organic solvent and/or polar aprotic organic solvent to the PFAS-contaminated water, the solvent/water solution is stirred or agitated. The stirring/agitation must be vigorous enough and continued for a long enough time to assure intimate contact between the PFAS-contaminated water and the added non-polar organic solvent and/or polar aprotic organic solvent and is continued for a sufficient time to assure through mixing of the non-polar organic solvent and/or polar aprotic organic solvent with the PFAS-contaminated water. If the non-polar organic solvent and/or polar aprotic organic solvent is immiscible in water, longer stirring/agitation times and/or more vigorous stirring/agitation may be needed. The stirring/agitation of the solution may be conducted using any suitable means, for example, a propeller mixer or the like.

Once the non-polar organic solvent and/or polar aprotic organic solvent has been thoroughly mixed with the PFAS-contaminated water, the water is separated from the solvent/water solution, during which the dissolved solids crystalize and the PFAS migrate to the non-polar organic solvent and/or polar aprotic organic solvent. After separation of the water, the remaining crystallized salts and PFAS-loaded non-polar organic solvent and/or polar aprotic organic solvent are separated.

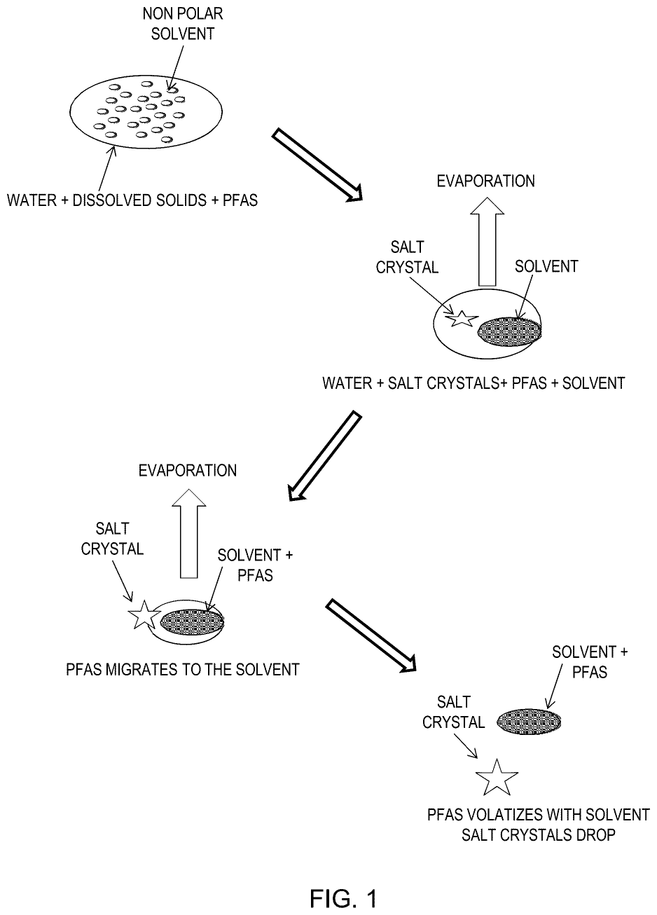

PFAS in solution with water tend to be ionic. Therefore, when water contaminated with PFAS is evaporated or distilled, the PFAS tend to remain with the water. In the inventive method, as shown schematically in FIG. 1, the PFAS migrate into the non-polar organic solvent and/or polar aprotic organic solvent and are driven towards more non-ionic forms. The dissolved solids (ionic salts) cannot move into the non-polar organic solvent and/or polar aprotic organic solvent and therefore remain in the water and crystalize. Therefore, the addition of the non-polar organic solvent and/or polar aprotic organic solvent facilitates the retention of the PFAS in the liquid phase while the salts are crystalizing and dropping away and the water is evaporating. After the evaporation of the water, substantially no PFAS remain in the water, for example, 99% of the PFAS may be removed from the PFAS-contaminated water.

The separation of the water from the solvent/water solution may take place by evaporating the water at a temperature above the boiling temperature of water at the pressure at which the evaporation process takes place, for example, 100° C. at atmospheric pressure (1 atm.; 760 mm Hg), and at a temperature below the boiling point of the non-polar organic solvent and/or polar aprotic organic solvent at the pressure at which the evaporation process takes place. For example, the evaporation temperature, may be 100° C. or more or 130° C. or more, and 200° C. or less, 170° C. or less, or 150° C. or less. Evaporation of the water can be conducted using any suitable means including spray drying, distillation, vacuum distillation, membrane distillation, multi-stage flash distillation, or evaporation in an evaporator.

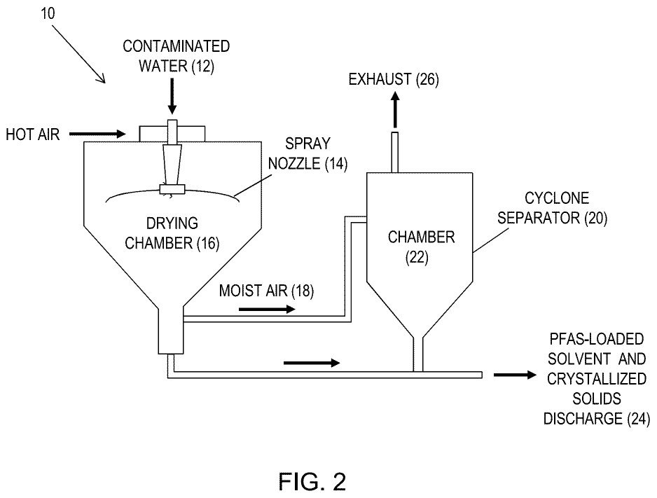

As shown in FIG. 2, the water may be separated from the solvent/water solution using a spray dryer (10). The solvent/water solution feed (12) is introduced to a spray nozzle (14), which converts the solution into a series of fine droplets of high surface area that are sprayed into a drying chamber (16). In the drying chamber (16), the fine droplets are contacted with hot gas and the water rapidly evaporates, the dissolved solids crystalize, and the PFAS is driven into the non-polar organic solvent and/or polar aprotic organic solvent, which remains in the liquid phase. The crystalized solids (salts) and the PFAS-loaded non-polar organic solvent and/or polar aprotic organic solvent may drop to the bottom of the drying chamber. The moist air (18) containing the water vapor may be fed to a cyclone separator (20), where any aerosolized droplets of the PFAS-loaded non-polar organic solvent and/or polar aprotic organic solvent and/or crystalized solids (salts) can be removed from the moist air. In the cyclone separator, the moist air (18) is injected into a chamber (22) to create a spiral vortex. Heavier components, such as PFAS-loaded non-polar organic solvent and/or polar aprotic organic solvent and the crystalized solids (salts), having more inertia are not easily influenced by the vortex and settle to the bottom of the chamber (22) and are discharged (24) from the system and moist air containing the water exits an exhaust (26) at the top of the chamber. The moist air may then be cooled to condense the water vapor producing distilled water containing substantially no PFAS.

Agitation of the solvent/water mixture as it enters the evaporation equipment and, depending on the evaporation equipment, during the evaporation process, for example, by boiling, can be beneficial, especially if the non-polar organic solvent and/or polar aprotic organic solvent is not water miscible.

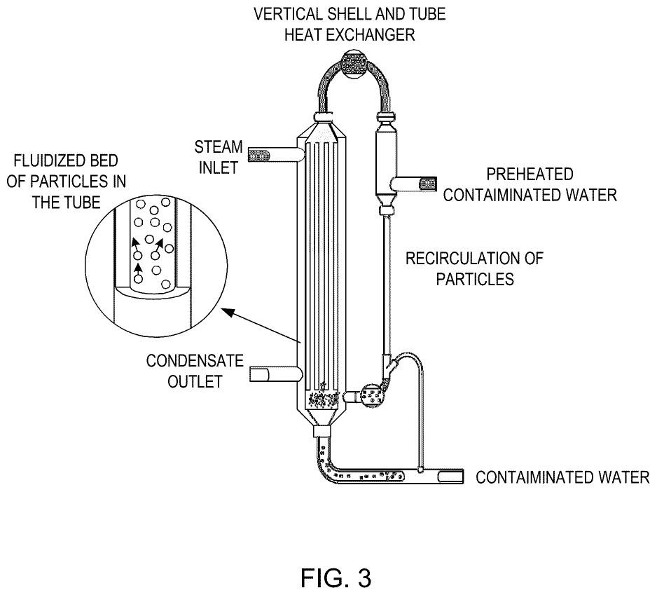

The contaminated water may be preheated prior to mixing with the non-polar organic solvent and/or polar aprotic organic solvent. For example, a fluidized bed heat exchanger may be used to preheat the contaminated water. In the fluidized reactor, particles are introduced into the contaminated water stream. The particles abrade and prevent the accumulation of scale on the heating surfaces and are removed from the preheated contaminated water and recycled back into the heat exchanger. FIG. 3 shows an example of a fluidized bed heat exchanger.

The PFAS-loaded non-polar organic solvent and/or polar aprotic organic solvent may then be separated from the crystalized solids (salts) using any suitable means including filtration, density separation, decantation, or the like.

The PFAS-loaded non-polar organic solvent and/or polar aprotic organic solvent may include residual water, for example, 15 wt % or less residual water.

Alternatively, if it is determined that the PFAS-contaminated water contains at least one non-polar organic solvent and/or polar aprotic organic solvent, the addition of the non-polar organic solvent and/or polar aprotic organic solvent can be omitted.

### Example 1

150 mL of contaminated water containing PFAS in the concentrations shown in Table 1 and 5000 mg/L NaCl (TDS) was mixed with an 150 mL of a polar aprotic organic solvent, N-methylpyrrolidinone (NMP), (solvent:water=1:1), and the water was evaporated from the solvent/water mixture at 100° C. in a laboratory distillation setup. The separated N-methylpyrrolidinone (NMP) contained 13.2 wt % residual water. The concentrations of PFAS contained in the distilled water and in the N-Methylpyrrolidinone (NMP) are shown in Tables 2 and 3, respectively.

TABLE 1

| | Concentration |
|---|---|
| Perfluoroalkyl/Polyfluoroalkyl Substance | (ng/L) |
| Perfluorobutanoic acid (PFBA; CAS No. 375-22-4) | 290,000 |
| Perfluorobutanesulfonic acid (PFBS; CAS No. | 270,000 |
| 375-73-5) | |
| Perfluorohexanoic acid (PFHxA; CAS No. 307-24-4) | 270,000 |
| Perfluorohexanesulfonic acid (PFHxS; CAS No. | 270,000 |
| 355-46-4) | |
| Perfluorooctanoic acid (PFOA; CAS No. 335-67-1) | 260,000 |

Max. Residue Limit (MRL)/Limit of Quantification (LOQ): 200 ng/L;
Dilution Factor: 100

TABLE 2

| | Concentration |
|---|---|
| Perfluoroalkyl/Polyfluoroalkyl Substance | (ng/L) |
| Perfluorobutanoic acid (PFBA; CAS No. 375-22-4) | None Detected |
| Perfluorobutanesulfonic acid (PFBS; CAS No. | None Detected |
| 375-73-5) | |
| Perfluorohexanoic acid (PFHxA; CAS No. 307-24-4) | None Detected |
| Perfluorohexanesulfonic acid (PFHxS; CAS No. | None Detected |
| 355-46-4) | |
| Perfluorooctanoic acid (PFOA; CAS No. 335-67-1) | None Detected |

Max. Residue Limit (MRL)/Limit of Quantification (LOQ): 200 ng/L;
Dilution Factor: 1

TABLE 3

| | Concentration |
|---|---|
| Perfluoroalkyl/Polyfluoroalkyl Substance | (ng/L) |
| Perfluorobutanoic acid (PFBA; CAS No. 375-22-4) | 93,000 |
| Perfluorobutanesulfonic acid (PFBS; CAS No. | 1,100,000 |
| 375-73-5) | |
| Perfluorohexanoic acid (PFHxA; CAS No. 307-24-4) | 620,000 |
| Perfluorohexanesulfonic acid (PFHxS; CAS No. | 1,000,000 |
| 355-46-4) | |
| Perfluorooctanoic acid (PFOA; CAS No. 335-67-1) | 670,000 |

Max. Residue Limit (MRL)/Limit of Quantification (LOQ): 250,000 ng/L;
Dilution Factor: 2000

### Comparative Example 1

150 mL of contaminated water containing PFAS in the concentrations shown in Table 1 and 5000 mg/L NaCl (TDS) was mixed with an 150 mL of a polar protic organic solvent, diethylene glycol monobutyl ether, (solvent:water=1:1) and the water was evaporated from the solvent/water mixture at 100° C. in a laboratory distillation setup. The concentrations of PFAS contained in the distilled water and in the diethylene glycol monobutyl ether are shown in Tables 4 and 5, respectively.

TABLE 4

| | Concentration |
|---|---|
| Perfluoroalkyl/Polyfluoroalkyl Substance | (ng/L) |
| Perfluorobutanoic acid (PFBA; CAS No. 375-22-4) | 330,000 |
| Perfluorobutanesulfonic acid (PFBS; CAS No. | 320,000 |
| 375-73-5) | |
| Perfluorohexanoic acid (PFHxA; CAS No. 307-24-4) | 280,000 |
| Perfluorohexanesulfonic acid (PFHxS; CAS No. | 270,000 |
| 355-46-4) | |
| Perfluorooctanoic acid (PFOA; CAS No. 335-67-1) | 270,000 |

Max. Residue Limit (MRL)/Limit of Quantification (LOQ): 200 ng/L;
Dilution Factor: 100

TABLE 5

| | Concentration |
|---|---|
| Perfluoroalkyl/Polyfluoroalkyl Substance | (ng/L) |
| Perfluorobutanoic acid (PFBA; CAS No. 375-22-4) | 200 |
| Perfluorobutanesulfonic acid (PFBS; CAS No. | 320 |
| 375-73-5) | |
| Perfluorohexanoic acid (PFHxA; CAS No. 307-24-4) | <MRL |
| Perfluorohexanesulfonic acid (PFHxS; CAS No. | <MRL |
| 355-46-4) | |
| Perfluorooctanoic acid (PFOA; CAS No. 335-67-1) | <MRL |

Max. Residue Limit (MRL)/Limit of Quantification (LOQ): 200 ng/L;
Dilution Factor: 1

As can be seen from Example 1, when a polar aprotic organic solvent is utilized, the distilled water is substantially free of PFAS, but when a polar protic organic solvent having high polarity is utilized, a substantial amount of the PFAS remain in the distilled water.

Additionally, it was found that, with the polar protic organic solvent (diethylene glycol monobutyl ether), the dissolved solids (NaCl) did not precipitate, and the presence or solubility of the dissolved solids (NaCl) in the solvent/water solution increased the ionic strength of the solvent/water solution, reduced the PFAS solubility, and forced the PFAS to remain with the water. With the polar aprotic organic solvent (NMP), the dissolved solids (NaCl) precipitated, the precipitation of dissolved solids (NaCl) increased the solubility of the PFAS in the organic solvent, and the PFAS was separated into the polar aprotic organic solvent (NMP).

Because organic solvents with high polarity tend to keep the dissolved solids in solution and have higher ionic strength, the PFAS solubility is lowered and the PFAS remain in the water during distillation. However, non-polar and polar aprotic organic solvents allow the dissolved solids to precipitate resulting in higher PFAS solubility, which allows the PFAS to be separated from the water during distillation.

The separated PFAS-loaded non-polar organic solvent and/or polar aprotic organic solvent may then subjected to supercritical water oxidation (SCWO). Organic compounds, usually insoluble in liquid water, are highly soluble in supercritical water where they can be rapidly oxidized and destroyed.

In supercritical water oxidation, the PFAS-loaded non-polar organic solvent and/or polar aprotic organic solvent is reacted with oxygen in water that has been heated above its thermodynamic critical point (374° C. and 221 bar). Supercritical water has both gas-like and liquid-like properties, and in supercritical water, organic compounds are soluble, oxygen is fully miscible, and salts are insoluble. In the presence of an oxidizing agent, such as oxygen, the unique properties of supercritical water accelerate oxidation organic compounds. During supercritical oxidation, the reaction of the organic molecules of the non-polar organic solvent and/or polar aprotic organic solvent and the PFAS with oxygen generates environmentally benign end products, such as water, carbon dioxide, and inorganic compounds. The exothermic reaction of the oxidation of the hydrocarbons results in both the destruction of the hydrocarbons and the release of heat to maintain the water at the critical temperature.

By subjecting the PFAS-loaded non-polar organic solvent and/or polar aprotic organic solvent to supercritical water oxidation, the PFAS are destroyed and converted to water, inorganic fluoride compounds, and carbon dioxide (CO₂) and the non-polar organic solvent and/or polar aprotic organic solvent is also destroyed and converted to water, inorganic compounds, and carbon dioxide (CO₂). These exothermic reactions act as a heat for the process, such that the non-polar organic solvent and/or polar aprotic organic solvent can be considered a fuel for the supercritical water oxidation destruction of the PFAS that reduces the amount of external energy that needs to be used for destruction of the PFAS. In addition, excess heat generated during the supercritical water oxidation or contained in water that is dispensed from the system can be used to preheat the contaminated water prior to evaporation or distillation and/or to heat the hot gas of the spray dryer.

The presence of dissolved solids (ionic salts) in the hydrocarbon containing feedstock for supercritical water oxidation can be harmful to the equipment. Supercritical water is no longer a solvent for ionic salts, so any ions (dissolved solids) in the water precipitate as salts during the transition of water to the supercritical phase. This can cause plugging of the supercritical water reactor, which can, in turn, cause malfunctions of the supercritical water system. In addition, the presence of some species, for example, chloride ion, in the feedstock can cause significant corrosion unless very highly alloyed metals are used. In addition, ionic species present in the feedstock can foul heat exchangers used in the super critical water oxidation process and the addition of chemicals commonly known to reduce scaling of the heat exchangers increases the amount of ionic species present in the SCWO system, potentially causing more scaling. Therefore, the PFAS-loaded non-polar organic solvent and/or polar aprotic organic solvent that has been separated from the water and the dissolved solids (salts; ionic species) present in the contaminated water is well suited for supercritical water oxidation.

The use of a fluidized bed reactor as the heat exchanger that heats the water for the supercritical water oxidation process can also reduce any scaling of the heat exchanger that may occur from any residual dissolved solids that remain in any residual water contained in the PFAS-loaded non-polar organic solvent and/or polar aprotic organic solvent.

Alternatively, the PFAS may be separated from the non-polar organic solvent and/or polar aprotic organic solvent and subjected to electrochemical oxidation.

Whereas particular aspects of this invention have been described above for purposes of illustration, it will be evident to those skilled in the art that numerous variations of the details of the present invention may be made without departing from the invention.

What is claimed is:

1. A method of separating perfluoroalkyl and/or polyfluoroalkyl substances (PFAS) from water contaminated with PFAS and containing dissolved solids, the method comprising:
providing contaminated water containing at least one perfluoroalkyl and/or polyfluoroalkyl substance and dissolved solids;
adding and mixing at least one non-polar solvent and/or at least one polar aprotic solvent into the water to form a solvent/water solution;
separating the water from the solvent/water solution, wherein the at least one perfluoroalkyl and/or polyfluoroalkyl substance migrates to the at least one non-polar solvent and/or the at least one polar aprotic solvent and the dissolved solids crystallize during mixing of the solvent/water solution and/or separation of the water; and
separating the crystallized solids from the at least one non-polar solvent and/or at least one polar aprotic solvent containing the at least one perfluoroalkyl and/or polyfluoroalkyl substance.

2. The method of claim 1, wherein the contaminated water contains 0.5-2,000,000 ppb of PFAS and 300-200,000 mg/L of total dissolved solids (TDS).

3. The method of claim 1, wherein a boiling point of each of the at least one non-polar organic solvent and/or at least one polar aprotic organic solvent is 150° C.-400° C.

4. The method of claim 1, wherein a ratio of an amount of the at least one non-polar organic solvent and/or at least one polar aprotic organic solvent added to the contaminated water and an amount of contaminated water (solvent:water) is 1:50 to 1:1.

5. The method of claim 1, wherein, during mixing, the solvent/water solution is agitated or stirred to provide contact between the contaminated water and the at least one non-polar organic solvent and/or at least one polar aprotic organic solvent.

6. The method of claim 1, wherein distillation or evaporation is used to separate the water from the solvent/water solution.

7. The method of claim 6, wherein the distillation or evaporation is conducted at a temperature above a boiling point of water and below the boiling point of the at least one non-polar organic solvent and/or at least one polar aprotic organic solvent.

8. The method of claim 6, wherein the water is separated from the solvent/water solution by spray drying.

9. The method of claim 1, wherein the solvent/water solution is agitated during entry into water separation and/or during water separation.

10. The method of claim 1, wherein after separation of the water from the solvent/water solution the water contains 0-10 ppt of PFAS.

11. The method of claim 1, wherein the at least one non-polar organic solvent and/or at least one polar aprotic organic solvent containing the PFAS and separated from the crystallized solids contains 15 wt % or less residual water.

12. A method of separating and destroying perfluoroalkyl and/or polyfluoroalkyl substances (PFAS) in water contaminated with PFAS and containing dissolved solids, the method comprising:
separating the at least one destroying perfluoroalkyl and/or polyfluoroalkyl substance from the contaminated water according to the method of claim 1;
subjecting the at least one non-polar organic solvent and/or at least one polar aprotic organic solvent containing the at least one destroying perfluoroalkyl and/or polyfluoroalkyl substance to supercritical water oxidation (SCWO).

13. The method of claim 12, wherein an exothermic reaction between the at least one non-polar organic solvent and/or at least one polar aprotic organic solvent and the supercritical water provides heat that fuels the supercritical water oxidation (SCWO).

14. The method of claim 12, wherein the contaminated water is preheated prior to separation of the water from the solvent/water solution using heat generated by the supercritical water oxidation (SCWO).
